(19) United States
(12) Patent Application Publication
(10) Pub. No.: US 2016/0257528 A1
(43) Pub. Date: Sep. 8, 2016

(54) MANAGEMENT OF SAFETY AND NON-SAFETY SOFTWARE IN AN ELEVATOR SYSTEM

(71) Applicant: OTIS ELEVATOR COMPANY, Farmington, CT (US)

(72) Inventors: Frank KIRCHHOFF, Berlin (DE); Peter HERKEL, Berlin (DE); Andreas TUTAT, Berlin (DE)

(21) Appl. No.: 15/028,774

(22) PCT Filed: Oct. 15, 2013
(86) PCT No.: PCT/US2013/064958

§ 371 Date: Apr. 12, 2016

(51) Int. Cl. B66B 1/34; B66B 5/02; B66B 1/28

(52) U.S. Cl. CPC B66B 1/3423; B66B 1/28; B66B 5/02

(57) ABSTRACT

An elevator controller includes a memory; an input/output unit; and a processor, the processor executing certified safety software and non-safety software, the non-safety software executed in a safe container to prevent the non-safety software from violating a non-safety software parameter and affecting the safety software.

### FIELD OF INVENTION

The subject matter disclosed herein relates generally to the field of elevator software, and more particularly, to the management of safety and non-safety software in an elevator system.

### BACKGROUND

Elevator controllers provide both safety and non-safety functions. Existing elevator systems execute safety software and non-safety software on separate controllers. This results in additional hardware cost and higher system complexity. Other existing elevator systems execute safety software and non-safety software on a single controller. While such systems reduce hardware cost, if non-safety software and safety software are running on the same controller, both the non-safety software and safety software must be certified. Modification of the non-safety software requires a recertification of both the non-safety software and safety software.

### SUMMARY

According to an exemplary embodiment, an elevator controller includes a memory; an input/output unit; and a processor, the processor executing certified safety software and non-safety software, the non-safety software executed in a safe container to prevent the non-safety software from violating a non-safety software parameter and affecting the safety software.

According to another exemplary embodiment, a method for executing certified safety software and non-safety software on an elevator controller includes executing the certified safety software and the non-safety software, the non-safety software executed in a safe container to prevent the non-safety software from violating a non-safety software parameter and affecting the safety software.

Other aspects, features, and techniques of embodiments of the invention will become more apparent from the following description taken in conjunction with the drawings.

### BRIEF DESCRIPTION OF THE DRAWINGS

Referring now to the drawings wherein like elements are numbered alike in the FIGURES:

FIG. 1 is a block diagram of components of an elevator system in an exemplary embodiment;

FIG. 2 depicts a controller in an exemplary embodiment; and

FIG. 3 is a flowchart of operation of the controller in an exemplary embodiment.

### DETAILED DESCRIPTION

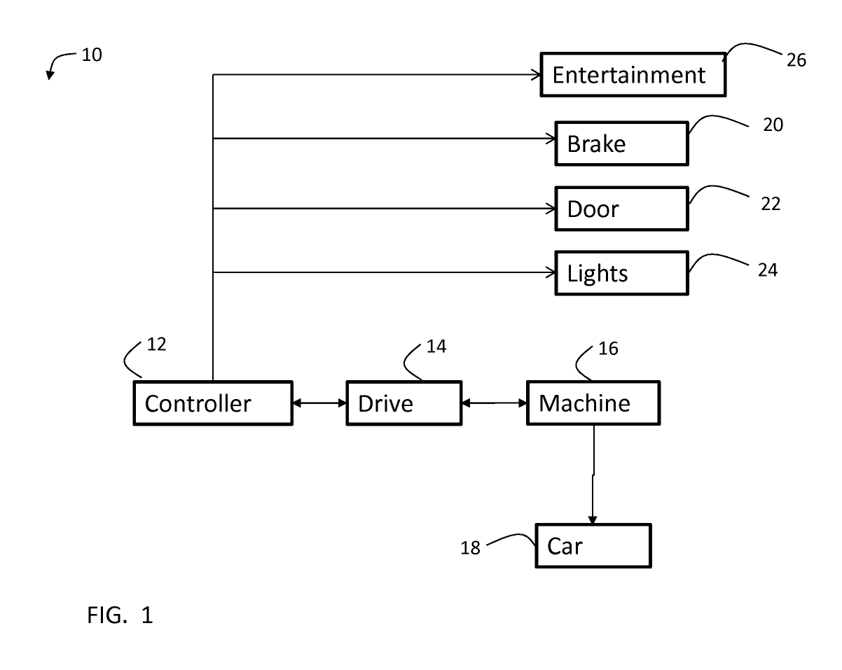

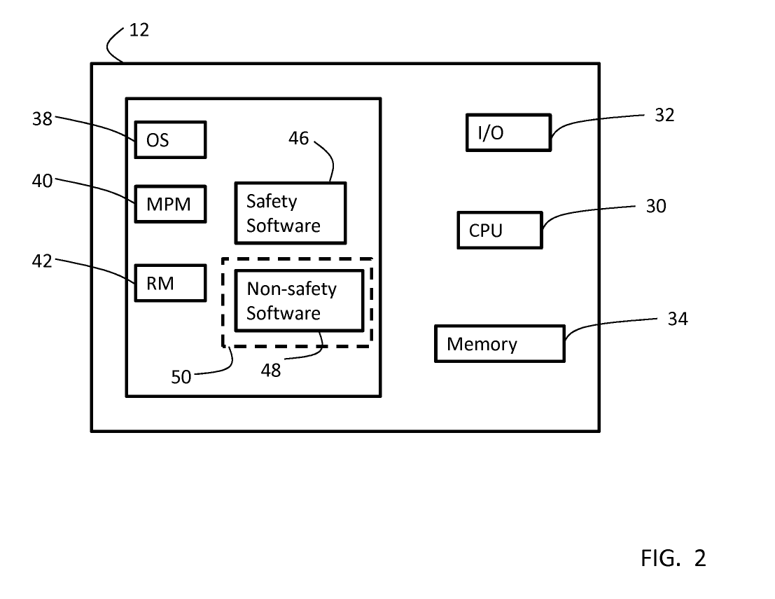

FIG. 1 is a block diagram of components of an elevator system 10 in an exemplary embodiment. It is understood that elevator system 10 may include a larger number of components, and FIG. 1 is simplified representation for ease of explanation. Elevator system 10 includes a controller 12 coupled to a drive 14 that provides drive signals to a machine 16 to impart motion to elevator car 18. Controller 12 may be implemented by a general-purpose microprocessor based device, executing computer program code in a storage medium to perform operations described herein. Controller 12 is described in further detail with reference to FIG. 2. Drive 14 may be an inverter that converts DC power to multiphase (e.g., three phase) drive signals in response to commands from controller 12. Machine 16 may be a multiphase (e.g., three phase) motor that imparts motion to elevator car 18. Although a single elevator car 18 is shown, controller 12 may be associated with multiple elevators cars. Controller 12 may receive commands from a dispatch system/group controller (not shown) and directs elevator car 18 in response to the commands.

In addition to controlling motion of elevator car 18, controller 12 interfaces with other system components, including elevator car brake 20, elevator car door 22, elevator car lights 24 and elevator car entertainment system 26. It is understood that controller 12 may interface with a variety of other system components, and the elements in FIG. 1 are exemplary. Certain system components are related to safety (i.e., brake 20, door 22, lights 24) and certain components are related to non-safety (i.e., entertainment system 26). FIG. 2 depicts a controller 12 in an exemplary embodiment. Controller 12 isolates software related to safety functions from software related to non-safety functions, and controls execution of the both the safety software and non-safety software to prevent interruption of the safety software by the non-safety software. As shown in FIG. 2, controller 12 includes a processor 30, input/output unit 32 and memory 34 (e.g., RAM, ROM). Input/output unit 32 may include a variety of signal formats, including serial, analogue, discrete, frequency, PWM, etc.

Software executing on controller 12 includes operating system 38, memory protection manager 40 and resource manager 42. Although shown as separate elements, memory protection manager 40 and resource manager 42 may be components of operating system 38. Memory protection manager 40 may be implemented as part of a memory protection unit of processor 30.

Controller 12 also executes safety software 46 and non-safety software 48. Safety software 46 provides control of elevator safety functions, such as imparting motion to elevator car 18, controlling brake 20, opening car door 22 and controlling elevator car lights 24. Non-safety software 48 provides control of elevator non-safety functions, such as entertainment system 26, which may stream information to an in-car display (news, weather, local events, etc.).

In order to isolate the non-safety software 48 from the safety software 46, controller 12 implements a safe container 50 that controls and limits operation of the non-safety software 48. Safe container 50 may be configured and enforced by operating system 38, including memory protection manager 40 and resource manager 42. Safe container 50 is a certified mechanism to protect the certified safety software 46 from threats or interruptions from the non-safety software 48. Possible threats include forbidden accesses by non-safety software 48 to safety related inputs and outputs of the controller 12, non-safety software 48 writes on data of the safety software 46 and blocking execution the safety software 46 (e.g. excessive runtime of the non-safety software 48). Safe container 50 allocates controller resources (e.g., memory 34, I/O unit 32) for non-safety software 48 and supervises the accesses in the defined boundaries. Forbidden accesses will be detected and suitable countermeasures are taken (e.g., pausing non-safety software 48 or stopping the elevator). Safe container 50 supervises the runtime of the non-safety software 48. The runtime can be supervised, for example, by resource manager 42 starting a timer with a preset value and stopping execution of the non-safety software 48 if the timer is run out. If a failure is detected, suitable countermeasures are taken (e.g., pausing non-safety software 48 partly or completely or stopping the elevator).

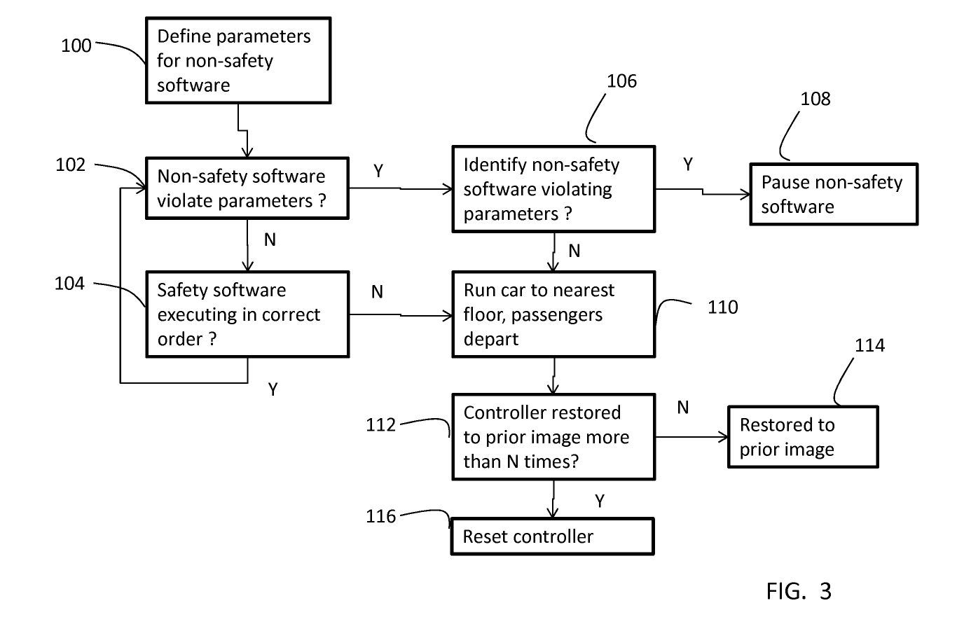

FIG. 3 is a flowchart of operation of the controller 12 in an exemplary embodiment. The process begins at 100 where non-safety software parameters for non-safety software 48 are defined. The parameters may include one or more of (i) limits on access to I/O unit 32 (ii) limits on access to certain portions of memory 34 and/or configuration registers and (iii) limits on use of processor 30 (e.g., runtime limits). Once the parameters for non-safety software 48 are defined, flow proceeds to 102 where it is determined if the non-safety software 48 has violated one or more parameters. A violation may be detected, for example, by memory protection manager 40 determining that non-safety software 48 is attempting to access a region of memory 34 allocated to safety software 46. A violation may be detected, for example, by resource manager 42 determining that a runtime limit (e.g., measured in time or number of instructions) has been exceeded by non-safety software 48.

If the non-safety software 48 has not violated any parameters at 102, flow proceeds to 104 where it is determined if the safety software 46 is executing in the proper order. This may be performed by processor 30 comparing a current order of instructions to a reference order of instructions to confirm that the safety software 46 is executing as intended. If the current order of instructions matches the reference order of instructions, flow returns to 102.

If at 102, the non-safety software 48 has violated a parameter, flow proceeds to 106 where controller 12 attempts to identify the particular non-safety software 48 that has violated a parameter. Non-safety software 48 may include a number of modules for different tasks (e.g., streaming music from local server and retrieving weather from a remote server). If the particular non-safety software 48 violating the parameter can be identified, then that non-safety software 48 may be paused at 108. The process may return to 102.

If the safety software 46 is not executing in the correct order at 104, or the non-safety software 48 violating a parameter cannot be identified at 106, flow proceeds to 110 where an appropriate response to the violation is selected, e.g., the elevator car 18 is stopped immediately and/or the elevator car 18 is directed to the nearest landing and the passengers depart the car. If the detected violation permits the controller 12 is restored to a prior uncorrupted controller image At 112 it is determined (e.g., by processor 30) whether controller 12 has been restored to a prior controller image more than N times. As known in the art, a processor-based device can be restored to a prior status (referred to as an image) in the event of an error. If at 112, controller 12 has not been restored to a prior controller image more than N times, flow proceeds to 114 where controller 12 is restored to a prior image. The process may return to 102. If at 112 it is determined that controller 12 has be restored to a prior controller image more than N times, flow proceeds to 116 where controller 12 is reset (e.g., reboot). The process may return to 102. Any of blocks 108, 114 and 116 may be accompanied by a notification to a maintenance system of the action taken and the need for maintenance of the controller 12.

Embodiments provide a number of advantages over existing designs. Everything but the non-safety software 48 is certified. The non-safety software 48 is not certified and can be changed without impacting the certificate of the safety software 46. The certification of safety software 46 can be simplified, if a pre-certified microcontroller and a pre-certified operating system 38 are used. Embodiments have less hardware cost and less communications overhead, as a single controller 12 is used. Embodiments allow the non-safety software 48 to be updated without impact on the certification of the safety software 46, providing maintenance flexibility. The non-safety software parameters prevent the non-safety software from affecting operation of the safety software.

As described above, the exemplary embodiments can be in the form of processor-implemented processes and devices for practicing those processes, such as processor 30 of controller 12. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes a device for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions, or equivalent arrangement not hereto described will be apparent to those of ordinary skill in the art without departing from the scope and spirit of the invention. Additionally, while the various embodiments of the invention have been described, it is to be understood that aspects of the invention may include only some of the described embodiments and that various aspects of the invention, although described in conjunction with one exemplary embodiment may be used or adapted for use with other embodiments even if not expressly stated. Accordingly, the invention is not to be seen as being limited by the foregoing description, but is only limited by the scope of the appended claims.

1. An elevator controller comprising:
a memory;
an input/output unit; and
a processor, the processor executing certified safety software and non-safety software, the non-safety software executed in a safe container to prevent the non-safety software from violating a non-safety software parameter and affecting the safety software.

2. The elevator controller of claim 1 wherein:
the non-safety software parameter includes access to the input/output unit, the safe container controlling non-safety software access to the input/output unit.

3. The elevator controller of claim 1 wherein:
the non-safety software parameter includes access to the memory, the safe container controlling non-safety software access to the memory and configuration register to control the processor and/or the peripheral components.

4. The elevator controller of claim 1 wherein:
the non-safety software parameter includes a runtime limit, the safe container controlling runtime of the non-safety software.

5. The elevator controller of claim 1 wherein:
the processor determines if the non-safety software violates the non-safety software parameter.

6. The elevator controller of claim 5 wherein:
when the processor identifies the non-safety software violating the non-safety software parameter, the processor pauses execution of the identified non-safety software.

7. The elevator controller of claim 5 wherein:
when the processor cannot identify the non-safety software violating the non-safety software parameter, the processor issues a command to immediately stop the elevator car or a command to direct an elevator car to a landing.

8. The elevator controller of claim 7 wherein:
the processor determines if a controller image has been restored more than N times, the processor restoring the controller to a prior controller image if the controller image has not been restored more the N times, the processor resetting the controller if the controller image has been restored more the N times.

9. The elevator controller of claim 1 wherein:
the processor determines if the safety software executes in a correct order.

10. The elevator controller of claim 9 wherein:
when the processor determines that the safety software executes in an incorrect order, the processor issues a command to stop the elevator car or a command to direct an elevator car to a landing.

11. A method for executing certified safety software and non-safety software on an elevator controller, the method comprising:
executing the certified safety software and the non-safety software, the non-safety software executed in a safe container to prevent the non-safety software from violating a non-safety software parameter and affecting the safety software.

12. The method of claim 11 wherein:
the non-safety software parameter includes access to the input/output unit, the safe container controlling non-safety software access to the input/output unit.

13. The method of claim 11 wherein:
the non-safety software parameter includes access to the memory, the safe container controlling non-safety software access to the memory.

14. The method of claim 11 wherein:
the non-safety software parameter includes a runtime limit, the safe container controlling runtime of the non-safety software.

15. The method of claim 11 further comprising:
determining if the non-safety software violates the non-safety software parameter.

16. The method of claim 15 further comprising:
pausing execution of the identified non-safety software when the non-safety software violates the non-safety software parameter.

17. The method of claim 15 further comprising:
issuing a command to direct an elevator car to a landing or stop the elevator car when the non-safety software violating the non-safety software parameter cannot be identified.

18. The method of claim 17 further comprising:
determining if a controller image has been restored more than N times;
restoring the controller to a prior controller image if the controller image has not been restored more the N times; and
resetting the controller if the controller image has been restored more the N times.

19. The method of claim 11 further comprising:
determining if the safety software executes in a correct order.

20. The method of claim 19 further comprising:
issuing a command to direct an elevator car to a landing or stop the elevator car upon determining that the safety software is executing in an incorrect order.
